(19) United States
(12) Patent Application Publication
(10) Pub. No.: US 2024/0129749 A1
(43) Pub. Date: Apr. 18, 2024

(54) REFLECTOR/SCATTERER FOR USE IN EXPANDING COMMUNICATION SERVICE COVERAGE AREA

(71) Applicant: ELECTRONICS AND TELECOMMUNICATIONS RESEARCH INSTITUTE, Daejeon (KR)

(72) Inventors: Jung Ick MOON, Daejeon (KR); Myung Sun SONG, Daejeon (KR); In Kui CHO, Daejeon (KR); Gwangzeen KO, Daejeon (KR); Sang-Won KIM, Daejeon (KR); Seong-Min KIM, Daejeon (KR)

(73) Assignee: ELECTRONICS AND TELECOMMUNICATIONS RESEARCH INSTITUTE, Daejeon (KR)

(21) Appl. No.: 18/334,131

(22) Filed: Jun. 13, 2023

(30) Foreign Application Priority Data
Oct. 18, 2022 (KR) 10-2022-0134196
Feb. 13, 2023 (KR) 10-2023-0018732

(51) Int. Cl. H04W 16/26; H01Q 15/14

(52) U.S. Cl. CPC H04W 16/26; H01Q 15/14

(57) ABSTRACT

Provided is a reflector/scatterer arranged around a side lobe beam which is generated from a transmission antenna, in a radiation direction of the side lobe beam, for use in expanding a communication service coverage area.

### CROSS-REFERENCE TO RELATED APPLICATION

This application claims the benefit of Korean Patent Application No. 10-2022-0134196, filed on Oct. 18, 2022, and Korean Patent Application No. 10-2023-0018732, filed on Feb. 13, 2023, in the Korean Intellectual Property Office, the entire disclosures of which are incorporated herein by reference for all purposes.

### BACKGROUND

### 1. Field of the Invention

One or more embodiments relate to antenna technology.

### 2. Description of the Related Art

Wireless communication technology using an antenna is developing in a trend of using a high frequency band (for example, a millimeter wave or a tera wave), which is advantageous in securing a wide frequency band for transmitting and receiving a lot of data at a high speed. For communication using a high frequency, it is necessary to understand and overcome the characteristics of an electromagnetic wave such as air loss, non-line-of-sight, diffraction, and scattering of the corresponding frequency.

In general, the higher the frequency, the greater the electromagnetic wave loss and accordingly, the communication coverage area expressed in cells decreases. Therefore, by using methods of increasing the output and gain of the antenna, or by installing a repeater or increasing the number of communication cells, an environment is established so that communication shadows do not occur in wide areas. Since these methods are related to the increase in costs for the construction and operation of indoor and outdoor wireless communication facilities, there are difficulties in applying these methods.

### SUMMARY

Embodiments provide a reflector/scatterer for expanding a communication service coverage area.

The technical goal obtainable from the present disclosure is not limited to the above-mentioned technical goal, and other unmentioned technical goals may be clearly understood from the following description by those skilled in the art.

According to an aspect of the present disclosure, provided is a reflector/scatterer arranged around a side lobe beam which is generated from a transmission antenna, in a radiation direction of the side lobe beam, for use in expanding a communication service coverage area.

In an embodiment, the reflector/scatterer may be formed in any one of a plate shape, a cylindrical shape, and a spherical shape.

In an embodiment, the reflector/scatterer may be formed of any one medium of metal, graphene, and a transparent electrode.

In an embodiment, the reflector/scatterer may include an inductor, a capacitor, or a diode.

In an embodiment, the reflector/scatterer may be arranged in multiple numbers in the radiation direction of the side lobe beam.

According to another aspect of the present disclosure, provided is a reflector/scatterer radially arranged around an isotropic antenna for use in expanding a communication service coverage area.

According to another aspect of the present disclosure, provided is a reflector/scatterer arranged in a radiation direction of a guided wave or a surface wave generated from a planar antenna, for use in expanding a communication service coverage area.

According to another aspect of the present disclosure, provided is an antenna system including an antenna and the reflector/scatterer.

Additional aspects of embodiments will be set forth in part in the description which follows and, in part, will be apparent from the description, or may be learned by practice of the disclosure.

According to embodiments, there is a technical effect of providing a reflector/scatterer for expanding a communication service coverage area.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIGS. 1A and 1B are diagrams illustrating a concept of expanding a communication service coverage area by arranging reflectors/scatterers according to the present disclosure around side lobe beams of a transmission antenna;

FIG. 2 is a diagram illustrating a concept of expanding a communication service coverage area by arranging reflectors/scatterers according to the present disclosure on the ceiling in a room where a transmission antenna is installed;

FIGS. 3A and 3B are diagrams illustrating a concept of expanding a communication service coverage area by arranging reflectors/scatterers according to the present disclosure around an isotropic antenna; and

FIG. 4 is a diagram illustrating a concept of expanding a communication service coverage area by arranging reflectors/scatterers according to the present disclosure around a planar antenna.

### DETAILED DESCRIPTION

The following structural or functional descriptions of embodiments described herein are merely intended for the purpose of describing the embodiments described herein and may be implemented in various forms. However, it should be understood that these embodiments are not construed as limited to the illustrated forms.

Various modifications may be made to the embodiments. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not to be limiting of the embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

Since communication using a high frequency uses a main beam of a high-gain antenna with good directivity, the beam width is small in proportion to the gain of the antenna. Therefore, a communication service coverage area is secured by generating multiple beams using an array antenna or adjusting the direction of the main beam toward a receiving antenna. On the other hand, when a high-gain antenna is used, side lobe beams (grating lobe beams) are naturally generated with the main beam, and thus, many efforts are made to reduce the intensity of the side lobe beams to increase the gain of the main beam used for communication. Therefore, it is common to regard the side lobe beams of an antenna as loss rather than communication.

In the present disclosure, the main beam of an antenna generally used for communication is left as the main beam is, and proposed are a technique for expanding and improving a communication coverage area by installing passive reflectors/scatterers around the antenna, especially the side lobe beams of the antenna, and a technique for effectively expanding a communication coverage area by intentionally adjusting the power ratio of the main beam and the side lobe beams and the direction of the side lobe beams in the direction of the reflectors/scatterers.

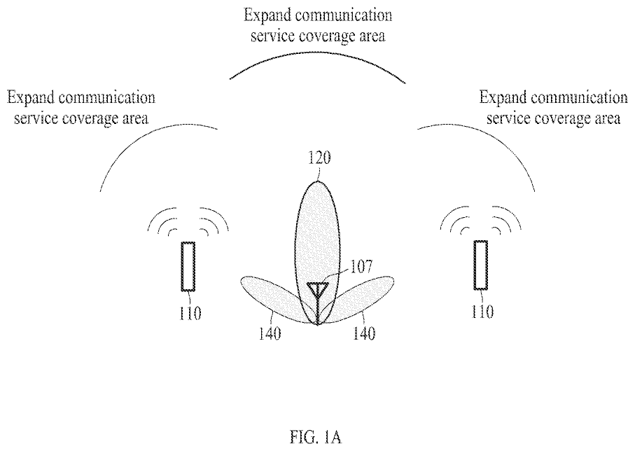

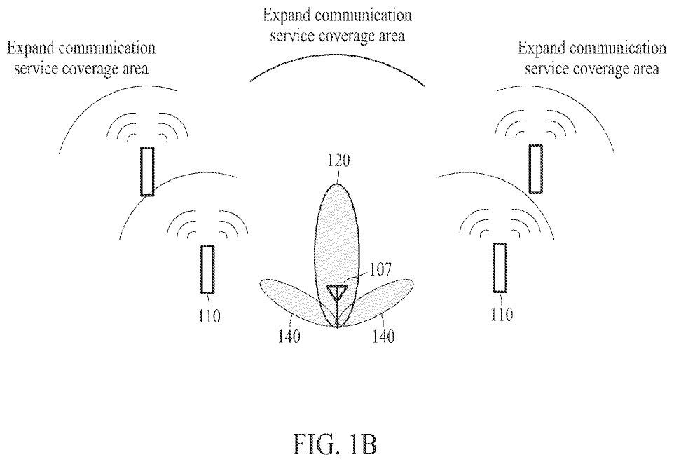

FIGS. 1A and 1B are diagrams illustrating a concept of expanding a communication service coverage area by arranging reflectors/scatterers according to the present disclosure around side lobe beams of a transmission antenna.

As illustrated in FIG. 1A, a main beam 120 of a transmission antenna 107 may be left as the main beam 120 is to be radiated in an originally intended direction, and reflectors/scatterers 110 according to the present disclosure may be appropriately arranged according to the direction and location where side lobe beams 140 of the transmission antenna 107 are generated. The reflectors/scatterers 110 may be arranged around the side lobe beams 140 of the transmission antenna 107 in the radiation direction, but the locations where the reflectors/scatterers 110 are arranged are not limited thereto. Since the reflectors/scatterers 110 include a passive element (for example, an object that performs its original function without using a separate power supply), a separate power supply from a repeater is not required, and thus, the reflectors/scatterers 110 may be installed in various locations depending on communication environments. In an embodiment in which the reflectors/scatterers 110 are designed in a plate shape, one surface of the reflectors/scatterers 110 may be arranged to face the side lobe beams 140 of the transmission antenna 107.

The location and arrangement of the reflectors/scatterers 110 may be set in the direction of the side lobe beams 140 by installing the reflectors/scatterers 110 in a far-field area of the transmission antenna 107. When a near-field characteristic of the transmission antenna 107 is identified through calculations or measurements even within the near-field, the reflectors/scatterers 110 may be installed in the near-field to expand the communication service coverage area. The shape and medium of the reflectors/scatterers 110 may be determined by using a design technique through various calculations and measurements. In an embodiment, an inductor or a capacitor may be inserted into the reflectors/scatterers 110 to adjust a resonance frequency advantageously for coverage expansion. Since the role of the reflectors/scatterers 110 is to expand the communication service coverage area, the reflectors/scatterers 110 may be designed in various shapes (e.g., a plate shape, a cylindrical shape, a spherical shape, a model with a distorted surface, etc.) and mediums (e.g., a metal, graphene, a transparent electrode, etc.), so that the side lobe beams 140 are irradiated to the reflectors/scatterers 110 and spread in a desired direction. In an embodiment, when a simple active element such as a diode is inserted into the reflectors/scatterers 110 and the side lobe beams of a certain level or higher are irradiated to the reflectors/scatterers 110, the beams may be deflected by controlling a current by operating the element or by artificially injecting a current into the element to operate.

Referring to FIG. 1B, an embodiment in which the reflectors/scatterers 110 are arranged in multiple shells in multiple numbers is illustrated. According to this embodiment, there is an effect of further expanding the communication service coverage area. Although FIG. 1B illustrates an embodiment in which the reflectors/scatterers 110 are arranged in a double layer, an embodiment in which the reflectors/scatterers 110 are arranged in triple or quadruple layers is also possible. In addition, since the energy radiated from the side lobe beams 140 is smaller than the energy emitted from the main beam 120, the reflected/scattered energy may also be small. In this case, the amount of energy radiated may be adjusted at an appropriate ratio by intentionally adjusting the power or gain of the main beam 120 and the side lobe beams 140.

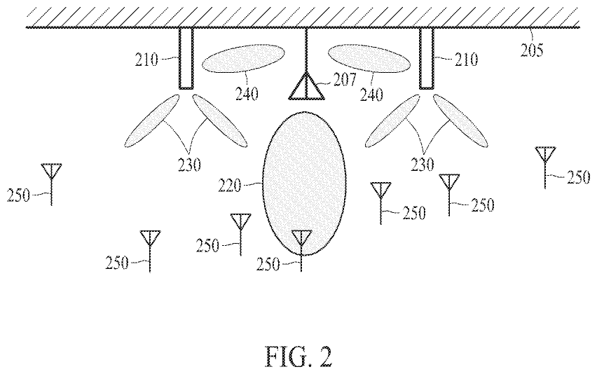

FIG. 2 is a diagram illustrating a concept of expanding a communication service coverage area by arranging reflectors/scatterers according to the present disclosure on the ceiling in a room where a transmission antenna is installed.

As illustrated in FIG. 2, by arranging reflectors/scatterers 210 according to the present disclosure on the ceiling 205 of a room where a transmission antenna 207 is installed, it is possible to expand the communication service coverage area without using many repeaters. As illustrated, by installing the reflectors/scatterers 210 around side lobe beams 240 generated by the transmission antenna 207 on the ceiling 205, the side lobe beams 240 are irradiated to the reflectors/scatterers 210 to generate reflected/scattered waves 230 and the reflected/scattered waves 230 may spread toward receiving antennas 250. Therefore, electric waves may be received even by the receiving antennas 250 that a main beam 220 does not reach and as a result, the communication service coverage area may be expanded.

FIG. 2 illustrates an embodiment in which the reflectors/scatterers 210 are arranged on the ceiling of a room, but an embodiment in which the reflectors/scatterers 210 are installed not only on the ceiling but also on the wall, floor, outer wall of a building, or outdoors, is also possible, to expand the communication service coverage area.

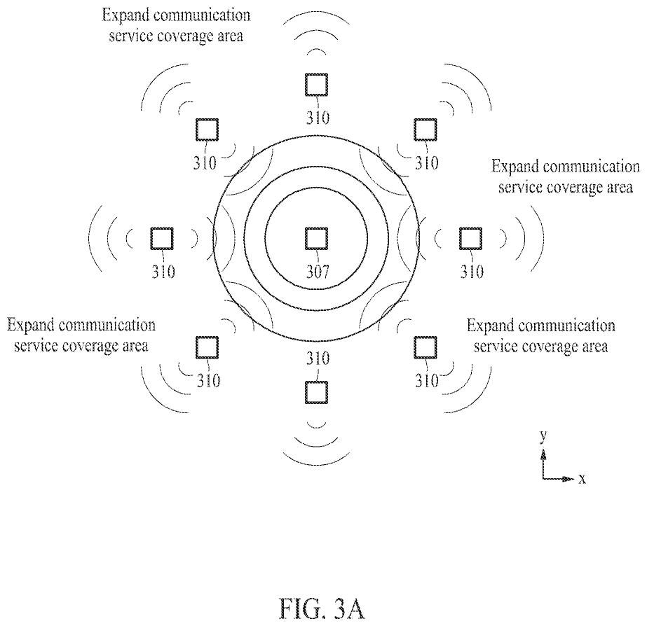

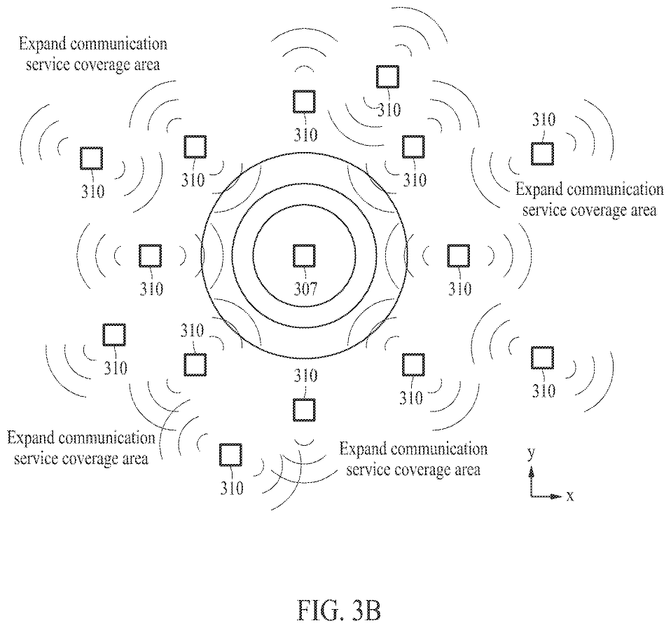

FIGS. 3A and 3B are diagrams illustrating a concept of expanding a communication service coverage area by arranging reflectors/scatterers according to the present disclosure around an isotropic antenna.

As illustrated, since a main beam is not distinguished from a side lobe in an isotropic antenna 307, the communication service coverage area may be expanded by arranging reflectors/scatterers 310 around the isotropic antenna 307. In an embodiment, the reflectors/scatterers 310 may be arranged at an equal angle as illustrated. In an embodiment, by arranging the reflectors/scatterers 310 asymmetrically and differently according to a user's intention, the communication service coverage area may be expanded in a specific direction. In an embodiment, as illustrated in FIG. 3B, the reflectors/scatterers 310 may be arranged in multiple numbers to reflect/scatter the beams in multiple layers. Although FIGS. 3A and 3B illustrate embodiments in which the reflectors/scatterers 310 are arranged around the isotropic antenna 307, the reflectors/scatterers 310 may also be arranged around the side lobe beams of a directional antenna so as to expand the communication service coverage area.

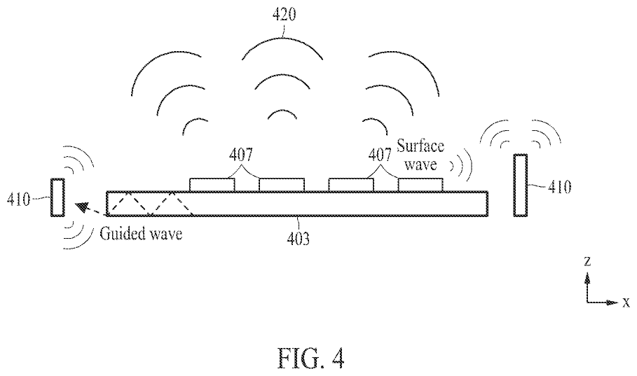

FIG. 4 is a diagram illustrating a concept of expanding a communication service coverage area by arranging reflectors/scatterers according to the present disclosure around a planar antenna.

Main beams 420 of planar antennas 407 are generally radiated in a direction (z direction) perpendicular to the plane, but it is common that a surface wave is generated in the x or y direction or a guided wave is generated along a substrate 403 and acts as a loss. Even in this case, the communication service coverage area may be expanded by properly arranging reflectors/scatterers 410 at a location where the surface wave and/or guided wave is generated, so that the surface wave and/or guided wave spreads in an appropriate direction.

In the embodiments disclosed herein, the arrangement of the illustrated components may vary depending on environments or requirements in which the technology is implemented. For example, some components may be omitted, or some components may be integrated and implemented as one. In addition, the arrangement order and connection of some components may be changed.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. A processing device may be implemented using one or more general-purpose or special purpose computers, such as, for example, a processor, a controller and an arithmetic logic unit, a DSP, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. The embodiments described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A reflector/scatterer arranged around a side lobe beam which is generated from a transmission antenna, in a radiation direction of the side lobe beam, for use in expanding a communication service coverage area.

2. The reflector/scatterer of claim 1, wherein
the reflector/scatterer is formed in any one of a plate shape, a cylindrical shape, and a spherical shape.

3. The reflector/scatterer of claim 1, wherein
the reflector/scatterer is formed of any one medium of metal, graphene, and a transparent electrode.

4. The reflector/scatterer of claim 1, wherein
the reflector/scatterer comprises an inductor, a capacitor, or a diode.

5. The reflector/scatterer of claim 1, wherein
the reflector/scatterer is arranged in multiple numbers in the radiation direction of the side lobe beam.

6. A reflector/scatterer radially arranged around an isotropic antenna for use in expanding a communication service coverage area.

7. A reflector/scatterer arranged in a radiation direction of a guided wave or a surface wave generated from a planar antenna, for use in expanding a communication service coverage area.
